(19) United States
(12) Patent Application Publication
(10) Pub. No.: US 2004/0214053 A1
(43) Pub. Date: Oct. 28, 2004

(54) Fuel cell

(76) Inventor: Fraser Armstrong, Oxford (GB)

Correspondence Address: NIXON & VANDERHYE, PC, 1100 N GLEBE ROAD, 8TH FLOOR, ARLINGTON, VA, 22201-4714, US

(21) Appl. No.: 10/487,456

(22) PCT Filed: Aug. 23, 2002
(86) PCT No.: PCT/GB02/03913

(30) Foreign Application Priority Data
Aug. 24, 2001 (GB) 0120698.6

(51) Int. Cl. H01M 4/90; H01M 4/96

(52) U.S. Cl. 429/13; 429/43; 429/44

(57) ABSTRACT

A fuel cell and a method of operating said fuel cell, which fuel cell comprises an anode having a catalyst adsorbed thereon, said catalyst comprising a hydrogenase which is in direct electronic contact with the anode.

The invention relates to fuel cells and methods of operating fuel cells.

Fuel cells are electrochemical devices that convert the energy of a fuel directly into electrochenical and thermal energy. Typically, a fuel cell consists of an anode and a cathode, which are electrically connected via an electrolyte. A file, which is usually hydrogen, is fed to the anode where it is oxidised with the help of an electrocatalyst. At the cathode, the reduction of an oxidant such as oxygen (or air) takes place. The electrochemical reactions which occur at the electrodes produce a current and thereby electrical energy. Commonly, thermal energy is also produced which may be harnessed to provide additional electricity or for other purposes.

Currently the most common electrochemical reaction for use in a fuel cell is that between hydrogen and oxygen to produce water. Molecular hydrogen itself may be fed to the anode where it is oxidised, the electrons produced passing through an external circuit to the cathode where oxidant is reduced Ion flow through an intermediate electrolyte maintains charge neutrality. Fuel cells may also be adapted to utilise the hydrogen from other hydrocarbon sources such as methanol or natural gas.

Fuel cells have many advantages over traditional energy sources. The major attractions of these systems are their energy efficiency and their environmental benefits. Fuel cells can be operated at an efficiency which is higher than almost all other known energy conversion systems and this efficiency can be increased further by harnessing the thermal energy produced by the cell. Further, fuel cells are quiet and produce almost no harmful emissions, even when running on fuels such as natural gas, since the system does not rely on the combustion of the fuel. Particularly advantageous are cells which operate on hydrogen, as these systems produce no emissions other than water vapour and their fuel source is renewable.

There is therefore a significant interest in developing commercially viable fuel cells. Aside from the obvious environmental benefits, there is a considerable need for a new and renewable source which will provide the necessary security, in terms of energy provision in the future, to our highly energy dependent society.

There are various barriers which have prevented the commercialization of fuel cell technologies. One of the major obstacles is cost and, in particular, the cost of the electrocatalyst. Currently, the most commonly used electrocatalyst is platinum. Platinum provides very efficient oxidation of hydrogen and enables high currents to be produced in the fuel cell. However, it is very costly, of limited availability and is a significant contributor to the expense of the fuel cell.

Platinum is also poisoned by carbon monoxide impurities, which are typically present in industrially produced hydrogen. Crude molecular hydrogen, in particular that obtained from fossil fuels, has a relatively high carbon monoxide content Although it is possible to filter out most of the carbon monoxide from the hydrogen before it comes into contact with the catalyst, this only adds to the cost of the system as a whole.

Alternatives to platinum catalysts have previously been suggested, but none has been found which is significantly cheaper than platinum, whilst retaining an acceptable catalytic efficiency. Raney nickel and other metal catalysts have been suggested, as have a few enzymatic catalysts. However, none of these can meet the demanding criteria for an electrocatalyst for a commercially viable fuel cell.

We have surprisingly found that hydrogenase enzymes, when directly adsorbed onto the anode, provide a competitive alternative to platinum for use as an electrocatalyst in a fuel cell. The current output from many previous fuel cells using enzymatic catalysts has been severely limited by the slowness of charge transfer between the biological species and the electrode. In most cases, this is because the biological species is not in direct electrical contact with the electrode; the electrical contact is instead made via a diffusing electrochemical mediator. Immobilization of a hydrogenase enzyme on the electrode in a way that creates an electrical contact can overcome this limitation. Such an electrode has been found to provide a surprisingly high current which is comparable to that obtained using platinum.

The present invention therefore provides a method of operating a fuel cell, which method comprises oxidising hydrogen at an anode having a catalyst adsorbed thereon, said catalyst comprising a hydrogenase which is in direct electronic contact with the anode.

In another aspect of the invention there is provided a fuel cell comprising an anode, having a catalyst adsorbed thereon, said catalyst comprising a hydrogenase which is in direct electronic contact with the anode.

The cost of producing the enzymes used in the present invention can be significantly lower than the cost of platinum. The expense of currently considered fuel cells is therefore greatly reduced by the use of the present invention. Further, the cost effectiveness of these enzymes is further increased by their production on a large scale, enabling the possibility of much larger scale fuel cell systems, such as industrial power plants, to be contemplated.

A further advantage of the present invention relates to the ability of the enzymatic catalysts to operate in the presence of carbon monoxide. Although carbon monoxide can bind to the active site of the enzymes, thus causing inactivation, this process is easily reversible without the need for severe conditions. If the concentration of hydrogen around the catalyst is much higher than that of carbon monoxide, the hydrogen will displace the carbon monoxide from the active site and the enzyme can operate as normal. Therefore, some degree of carbon monoxide contamination of the hydrogen fuel can be tolerated and the requirements regarding purification of the hydrogen used are much lower than that of fuel cell systems using platinum catalysts.

The present invention therefore enables enzymatic catalysts to be used as electrocatalysts in fuel cells. In addition, the catalysts used in the invention are highly efficient and cost effective and provide a real, commercially viable alternative to platinum catalysts. Further, the possibility of genetically engineering the enzymes may allow for adaptation of the enzyme to provide improved catalytic activity to suit the particular type of fuel, or fuel cell system, that is used.

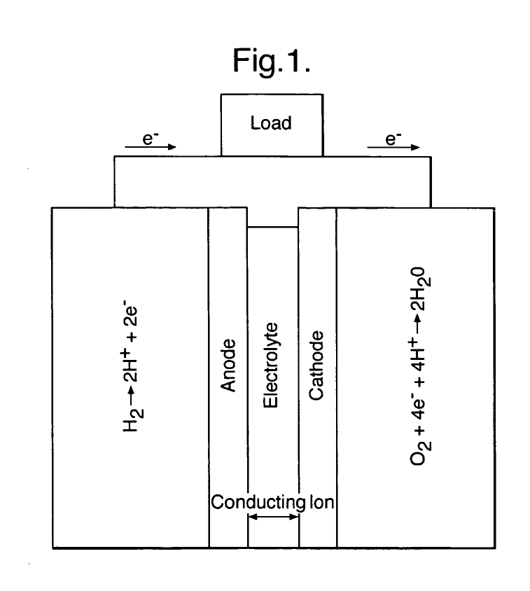

FIG. 1 depicts a fuel cell according to the invention.

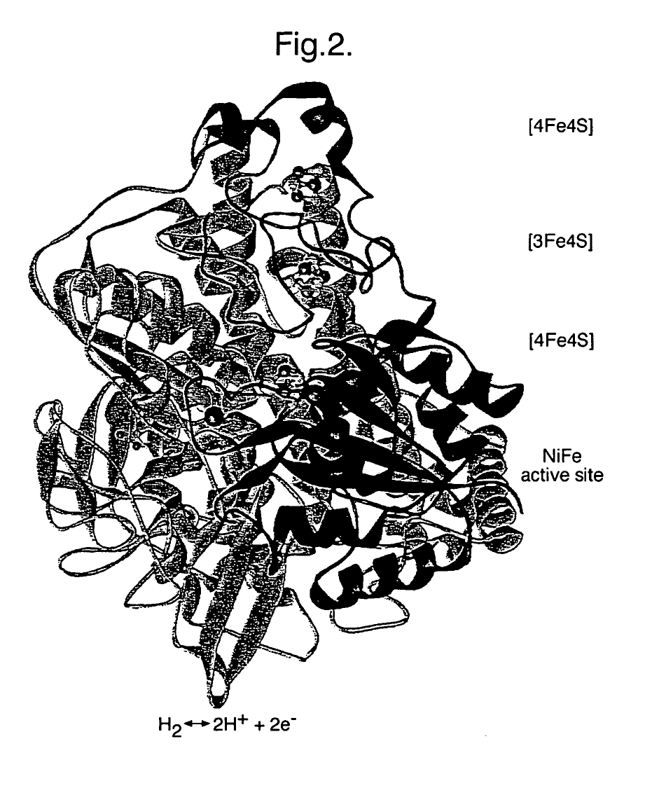

FIG. 2 depicts the structure of a hydrogenase molecule which is suitable for use in a catalyst of the invention.

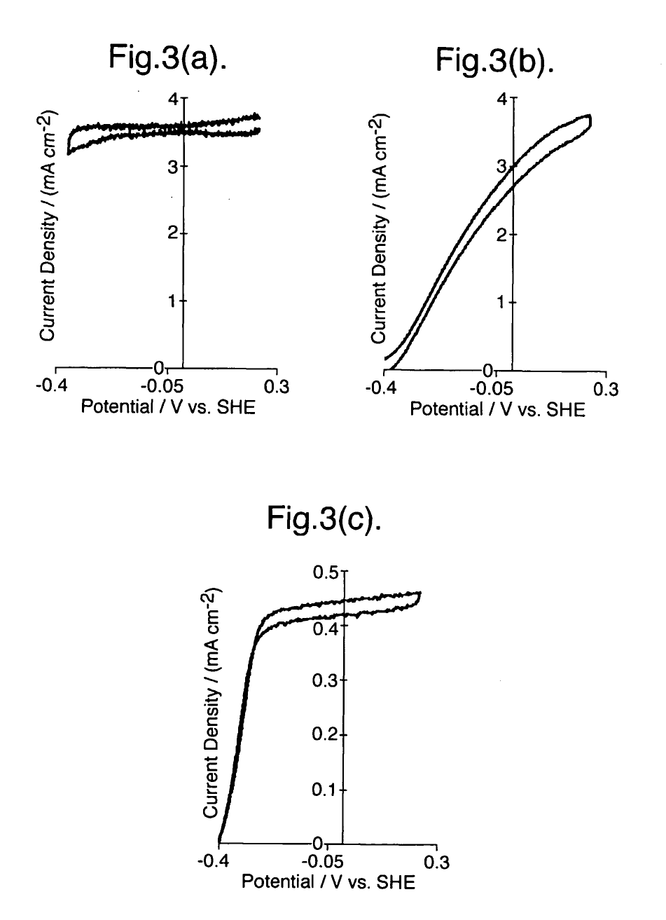

FIG. 3 depicts the potential dependence of hydrogen oxidation currents for platinized gold and Allochromatium vinosum [Ni—Fe] hydrogenase (AvH₂ase) at pH 7, 45° C. and 2500 rpm. a) Platinized gold in 100% hydrogen at 1 V s⁻¹. b) AvH₂ase in 100% hydrogen at 1 V s⁻¹. c) AvH₂ase in 10% hydrogen at 0.1 V s⁻¹.

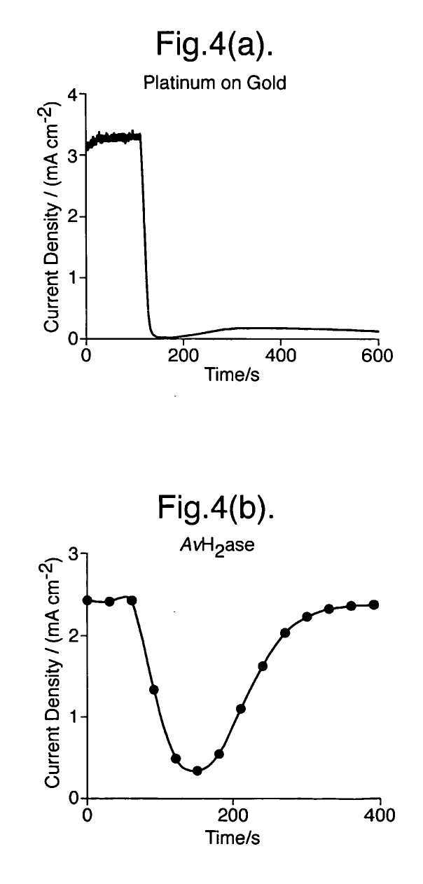

FIG. 4 depicts the effect of the introduction of carbon monoxide on hydrogen oxidation currents in 100% hydrogen at +0.242 V versus SHE, pH 7, 45° C. and 2500 rpm using both a platinum and an AvH₂ase catalyst.

Typically, the fuel cells of the invention comprise:

a fuel source which provides hydrogen to an anode;

an anode, coated with a catalyst, at which the hydrogen is oxidised;

an oxidant source which provides an oxidant to a cathode;

a cathode at which the oxidant is reduced and which is electrically connected to the anode via an electrical conductor, and

an electrolyte which serves as a conductor for ions between the anode and the cathode.

The present invention may be used in combination with any fuel cell, as long as the operating conditions are sufficiently mild that the hydrogenase catalyst is not denatured. For example, fuel cells which operate at very high temperatures, or which require extreme pH conditions, may well cause the hydrogenase catalyst to denature.

Conventional fuel cells which are currently used include alkaline, proton exchange membrane, phosphoric acid, molten carbonate and solid oxide fuel cells. Of these, the most suitable for use with the present invention is the proton exchange membrane cell. These cells typically operate at temperatures of from 50 to 90° C. and at substantially neutral pH. In proton exchange membrane fuel cells the reaction of hydrogen which occurs at the anode can be described according to the following equation (1):

H₂→2H⁺+2e⁻ (1)

The electrons produced are transferred via the conductor to the cathode and, similarly, the protons are transferred to the cathode via the electrolyte. The reaction which occurs at the cathode can be described according to the following equation (2):

$$\frac{1}{2} {O}_{2} + 2 {H}^{+} + 2 {e}^{-} \to {H}_{2} O \qquad ( 2 )$$

Thus, the overall reaction converts hydrogen and oxygen into water and generates an electric current.

Alternative fuel cells may involve slightly different reactions occurring at the anode and the cathode, depending on the conditions of the particular fuel cell used.

An example of a fuel cell according to the invention is described in FIG. 1. In this depiction, the fuel fed to the anode is hydrogen and the oxidant is oxygen. The two electrodes are separated physically but are electrically connected via the external circuit and the electrolyte. Electrons flow from the anode to the cathode via the external load.

The fuel cells of the present invention utilise hydrogen as a fuel. The source of hydrogen may be hydrogen gas itself or the hydrogen may be derived from an alternative source such as an alcohol, including methanol and ethanol, or from fossil fuels such as natural gas. Typically, hydrogen itself is used The hydrogen may be in a crude form and thus may contain impurities, or purified hydrogen may be used.

The fuel source is typically a gas which comprises hydrogen and which is provided to the anode. It is also conceivable that the fuel may be provided in liquid form. Generally, the fuel source also comprises an inert gas, although substantially pure hydrogen may also be used. For example, a mixture of hydrogen with one or more gases such as nitrogen, helium, neon or argon may be used as the fuel source.

The fuel source may optionally comprise further components, for example alternative fuels or other additives. The additives which may be present are preferably those which do not react with the catalyst which is coated on the positive electrode. If other entities are present which react with the catalyst, these should be present in as small an amount as possible. For example, carbon monoxide, which can react with the catalysts used in the present invention, is preferably present in an amount of less than 30% by volume, more preferably less than 10% by volume, for example less than 5% or less than 1% by volume. Higher concentrations of CO will lead to lower hydrogen oxidation currents. However, the effect of CO is reversible and the removal of CO from the fuel gas will lead to the restoration of the oxidation current.

Typically, hydrogen is present in the fuel source in an amount of at least 2% by volume, preferably at least 5% and more preferably at least 10% by volume, for example 25%, 50%, 75% or 90% by volume. Where an inert gas is used to form part of the fuel gas, the inert gas is typically present in an amount of at least 10%, such as at least 25%, 50 % or 75% by volume, most preferably at least 80% by volume.

Generally, the fuel source is supplied from an optionally pressurised container of the fuel source in gaseous or liquid form. The fuel source is supplied to the electrode via an inlet, which may optionally comprise a valve. An outlet is also provided which enables used or waste fuel source to leave the fuel cell.

The oxidant typically comprises oxygen, although any other suitable oxidant may be used. The oxidant source typically provides the oxidant to the cathode in the form of a gas which comprises the oxidant. It is also envisaged, however, that the oxidant may be provided in liquid form. Generally, the oxidant source also comprises an inert gas, although the oxidant in its pure form may also be used. For example, a mixture of oxygen with one or more gases such as nitrogen, helium, neon or argon may be used. The oxidant source may optionally comprise further components, for example alternative oxidants or other additives. An example of a suitable oxidant source is air.

Typically, oxygen is present in the oxidant source in an amount of at least 2% by volume, preferably at least 5% and more preferably at least 10% by volume.

Generally, the oxidant source is supplied from an optionally pressurised container of the oxidant source in gaseous or liquid form. The oxidant source is supplied to the electrode via an inlet, which may optionally comprise a valve. An outlet is also provided which enables used or waste oxidant source to leave the fuel cell.

The anode may be made of any conducting material for example stainless steel, brass or carbon, which may be graphite. The surface of the anode may, at least in part, be coated with a different material which facilitates adsorption of the catalyst. The surface onto which the catalyst is adsorbed should be of a material which does not cause the hydrogenase to denature. Suitable surface materials include graphite, for example a polished graphite surface or a material having a high surface area such as carbon cloth or carbon sponge. Materials with a rough surface and/or with a high surface area are generally preferred.

The cathode may be made of any suitable conducting material which will enable an oxidant to be reduced at its surface. For example, materials used to form the cathode in conventional fuel cells may be used. An electrocatalyst may, if desired, be present at the cathode. This electrocatalyst may, for example, be coated or adsorbed on the cathode itself or it may be present in a solution surrounding the catalyst. Suitable electrocatalysts include those used in conventional fuel cells such as platinum. Biological catalysts may also be used for this purpose.

The catalyst comprises one, or a mixture of, hydrogenases. The catalyst may also comprise further additives if desired. Suitable hydrogenases include those having a [Ni—Fe] and/or [Fe—Fe] active site, preferably a [Ni—Fe] active site. Hydrogenases having a [Ni—Fe] and/or [Fe—Fe] active site are found in many microorganisms and are thought to enzymatically catalyse the oxidation and/or reduction of hydrogen in those microorganisms. Examples of the microorganisms containing hydrogenases include methanogenic, acetogenic, nitrogen-fixing, photosynthetic, such as purple photosynthetic, and sulfate-reducing bacteria and those from purple photosynthetic bacteria are preferred. Particular examples of suitable hydrogenases include the hydrogenases from Allochromatium vinosum and Desulfovibrio gigas. Particularly preferred are the Allochromatium vinosum hydrogenases, i.e. the Allochromantium vinosum [Ni—Fe] hydrogenase.

The bacteria discussed above can generally be obtained commercially (for example Allochromatium vinosum can be obtained from DSMZ in Germany). The bacteria may be cultured to provide a sufficient quantity of enzyme for use in the fuel cell. This may be carried out, for example by culturing the enzyme in a suitable medium in accordance with known techniques. Cells may then be harvested, isolated and purified by any known technique.

The structure of the [Ni—Fe] hydrogenase active site in Allochromatium vinosum is thought to be responsible both for the base-assisted cleavage of the hydrogen molecule and the enzymatic redox behaviour. This active site is buried deeply within the structure of the Allochromatium vinosum hydrogenase molecule. The active site itself therefore is unlikely to exchange electrons directly with external substances. Instead, electrons are thought to move within the molecule via an electron relay system. This relay system is made up of several additional electrically active sites comprising Fe—S linkages which form a pathway for the electrons to travel to and from the active site. Each of these Fe—S sub-units forming the electron relay system, and the Ni—Fe active site itself, are highlighted in FIG. 2, which depicts the Allochromatium vinosum molecule. Further details regarding the [Ni—Fe] active site can be found, for example, in the article by Albracht et al (Biochim. Biophys. Acta 1188, 167-204(1994)).

The Allochromatium vinosum [Ni—Fe] hydrogenase active site has a structure which is typical of [Ni—Fe] hydrogenases and such typical [Ni—Fe] hydrogenases would therefore be expected to work in a similar manner to Allochromatium vinosum [Ni—Fe] hydrogenase. These hydrogenases may also be used in the present invention Further, any hydrogenase having an electrochernically active site (including [Ni—Fe] and [Fe—Fe] active sites) which can exchange electrons with an electrode, either directly or via an electron relay system such as that present in Allochromatium vinosum [Ni—Fe] hydrogenase, is suitable for use in the present invention.

The catalyst containing a hydrogenase is adsorbed onto the anode. This ensures that the hydrogenase is in direct electronic contact with the anode. The term “direct electronic contact”, as used herein, means that the catalyst is able to exchange electrons directly with the electrode. In this manner, the fuel cell of the invention may operate without the need for an independent electron mediator to transfer charge from the catalyst to the electrode. A preferred feature of the present invention resides in the substantial absence of an independent electron mediator.

A further advantage of the adsorption of the catalyst onto the anode resides in the availability of the hydrogenase for reaction. There is no longer a requirement for the hydrogenase to diffuse through the solution to the electrode before reaction can take place. Since the hydrogenase is typically a very large molecule, this diffusion can be slow and is a potentially rate-limiting step. Adsorption of the catalyst onto the electrode thus avoids this diffusion step. Further, the hydrogenase may be present in either an active or inactive state. A low electrode potential, such as is found at the anode surface, encourages the existence of the active site. Thus, hydrogenase molecules which are adsorbed to the anode will in general be activated, as long as the conditions are favourable.

The anode may be immersed in a suitable medium. This medium may be a solution of the catalyst, or an alternative medium, such as water, which does not contain further hydrogenate or contains only very low concentrations of hydrogenase. If bydrogenase is present in the medium, exchange may take place between the hydrogenase molecules adsorbed to the-anode and those in solution. To avoid the exchange of active molecules at the anode with potentially inactive molecules in solution, the concentration of hydrogenase in the medium should be minimised. This is of particular importance in situations where the conditions are such that much of the hydrogenase in solution is inactive, especially where the hydrogenase is only weakly adsorbed to the anode. In these situations the concentration of hydrogenase in the medium should preferably be kept at a minimum, preferably below 1 mM, more preferably below 0.1 μM or 0.01 μM.

Typically, the catalyst layer is adsorbed to the surface of the electrode using an attachment means. The attachment means is typically a polycationic material. Examples of suitable attachment means include large polycationic materials such as polyamines including polymixin and neomycin. The catalyst can be attached to the electrode surface as a submonolayer, a monolayer or as multiple layers, for example 2, 3, 4 or more layers. Preferably, at least 10% of the available surface of the anode is coated with catalyst. The “available surface” of the anode is the surface which is in contact with the fuel source. More preferably, at least 25%, 50% or 75% and particularly preferably at least 90% of the available surface of the anode is coated with catalyst.

Any suitable technique for preparing and coating the anode may be used. Where the surface of the anode is a polished graphite surface,-this surface may be polished using a suitable polishing means, for example an aqueous alumina slurry, prior to coating with the catalyst. Coating may be carried out by, for example, directly applying a concentrated solution of catalyst, optionally mixed with an attachment means, to the electrode surface, e.g. by pipette. Alternatively and preferably, the catalyst, optionally together with the attachment means, may be made up into a dilute aqueous solution (for example a 0.1 to 1.0 μM solution of hydrogenase). The electrode is then inserted into the solution and left to stand. A potential may be applied to the electrode during this period if desired. The potential enables the degree of coating with the catalyst to be easily monitored. Typically, the potential will be increased and then subsequently decreased within a range of from approximately −0.5 to 0.2V vs SHE and the potential cycled in this manner for up to 10 minutes at a-rate of 0.01 V/s, typically for about 5 or 6 minutes.

The fuel cells of the present invention comprise an electrolyte suitable for conducting ions between the two electrodes. The electrolyte should preferably be one which does not require the fuel cell to be operated under extreme conditions which would cause the hydrogenase to denature. Thus, electrolytes which rely on high temperature or extreme pH should be avoided. Other than these requirements, any suitable electrolyte may be used for this purpose. For example, a proton exchange membrane such as Nafion™ may be used or any other suitable electrolyte which is known in the art.

The conditions under which the fuel cell is operated are important in terms of the amount of current that can be generated from the cell. In particular, the conditions are an important consideration in keeping the hydrogenase in its active state. The presence of oxidants is one condition which causes inactivation of the bydrogenase. Thus, the anode of the fuel cell having catalyst adsorbed thereon must be physically separated from the oxidant.

The partial pressure of hydrogen supplied to the anode and the pH of the medium surrounding the anode also affect the active state of the hydrogenase. Preferably, the conditions should be maintained such that as much of the hydrogenase is in the active state as possible. For example, at least 50%, preferably at least 70%, 80%, 90% or 95% of the hydrogenase adsorbed to the anode should be in the active state. This can in general be achieved by adjusting the conditions such that the potential at the anode is not above about 0.3V vs SHE, preferably not above about 0.2V, 0V or −0.2V or −0.4V, all vs SHE.

The pH of any medium which is in contact with the hydrogenase is typically maintained at approximately 7. However, the pH can generally be from approximately 6 to 8, typically from 6.5 to 7.5. Variation within these limits may be used to increase the proportion of hydrogenase which is in the active state.

The partial pressure of hydrogen which is supplied to the anode may also be varied to ensure that the hydrogenase is active. An increased partial pressure will encourage the hydrogenase to take up its active form. Suitable hydrogen partial pressures for use in the cell are at least 1×10⁴ Pa, preferably at least 2×10⁴ Pa, such as at least 5×10⁴, 1×10⁵ or 1×10⁶ Pa.

The fuel cell of the present invention is typically operated at a temperature of at least 25° C., more preferably at least 30° C. It is particularly preferred that the fuel cell is operated at a temperature of from 35 to 65° C., such as from 40 to 50° C. A higher temperature increases the rate of reaction and leads to a higher oxidation current. However, temperatures which are above about 65° C. may lead to damage to the hydrogenase and should therefore be avoided.

A fuel cell, as described above, may be operated under the conditions described above, to produce a current in an electrical circuit The fuel cell is operated by supplying hydrogen to the anode and supplying an oxidant to the cathode. The fuel cell of the invention is capable of producing current densities of at least 0.5 mA, typically at least 0.8 mA, 1 mA or 1.5 mA per cm² of surface area of the positive electrode. For example, the fuel cell of the invention may produce a current of at least 2 mA, such as at least 3 mA per cm² of surface area of the positive electrode.

The fuel cell of the present invention is therefore envisaged as a source of electrical energy which might replace conventional platinum electrode-based fuel cells.

The invention is illustrated in more detail by the following Example:

### EXAMPLE

Laboratory scale electrodes were prepared having a catalyst coating (a) of platinum as is found in conventional fuel cells and (b) of a catalyst according to the present invention. These electrodes were tested to provide a comparison of the current densities which would be obtained in a fuel cell and of the reaction of the catalysts to carbon monoxide.

1. Preparation of Electrodes

a) A gold (99.9985%, Alfa, UK) rotating disk electrode was manufactured and cleaned according to standard techniques. Clean platinum surfaces were 5 electrodeposited onto the electrode from 5mM hydrogen hexachloroplainate (I) hydrate (Aldrich) in accordance with White et al, Electroanalysis 6, 625-632 (1994).

b) Allochromatium vinosum was grown as a 700 liter batch culture in a suitable medium. Cells were harvested and Allochromatium Vinosum [Ni—Fe] hydrogenase (AvH₂ase) was isolated and purified in accordance with standard techniques. The purity of the samples was checked by gel electrophoresis using an SDS-polyacrylamide (12%) gel, and the protein concentrations were determined by the method of Bradford (Anal. Biochem. 72, 248-254 (1976)) using bovine serum albumin as a standard.

The hydrogenase was coated onto a pyrolytic graphite edge rotating disk electrode by inserting the electrode in a 1.0 μM solution of AvH₂ase and cycling the electrode potential between 0.242 and −0.558 V vs. SHE at 100 m V/s for 5 minutes.

2. Current Density Experiments

Cyclic voltammograms were obtained for both electrodes as follows:

a) platinum coated electrode in 100% hydrogen

b) AvH₂ase coated electrode in 100% hydrogen

c) AvH₂ase coated electrode in 10% hydrogen/90% nitrogen.

All AvH₂ase experiments were conducted at 45° C., pH7 in a mixed buffer as described in Pershad et al, Biochemistry 38, 8992-9888 (1999). The platinum experiment was carried out in a similar manner but using a chloride free 0.1M phosphate buffer.

As shown by FIG. 3, the use of an AvH₂ase catalyst can achieve a current density which is similar to that of platinum. Improved results are seen when a greater partial pressure of hydrogen is present.

3. Carbon Monoxide Experiments

Cyclic voltammetry was carried out in a similar manner to experiments (2) above. However, after the hydrogen oxidation current stabilized, carbon monoxide was added to the experimental solution for ten seconds. The platinum data (FIG. 4a) was collected as a chronoamperometric trace. The AvH₂ase trace (FIG. 4b) was constructed from currents measured in cyclic voltammograms recorded at 1 V s⁻¹ between −0.558 V and +242 V vs. SHE with a thirty second delay between each voltammogram (individual points are shown).

The data demonstrates that carbon monoxide is a competitive inhibitor of both platinum and AvH₂ase. However, inhibition is reversed in the case of AvH₂ase by displacement of CO with hydrogen. In contrast, at the potentials used in this experiment, the platinum surface was quickly and irreversibly poisoned such that at most 10% of the initial activity remained.

1. A method of operating a fuel cell, which method comprises oxidising hydrogen at an anode having a catalyst adsorbed thereon, said catalyst comprising a hydrogenase which is in direct electronic contact with the anode.

2. A method according to claim 1, wherein the hydrogenase contains an [Ni—Fe] active site.

3. A method according to claim 2, wherein the hydrogenase is Allochromatium vinosum [Ni—Fe] hydrogenase.

4. A method according to claim 1, wherein the catalyst is coated on the anode using a polycationic substance as adhesive.

5. A method according to claim 4, wherein said polycationic substance is polymixin.

6. A method according to claim 1 wherein at least 50% of the hydrogenase is in its active form.

7. A method according to claim 1 wherein the partial pressure of hydrogen at the anode is greater than 1×10⁴ Pa.

8. A method according to claim 1, wherein the fuel cell is maintained at a temperature of at least 30EC.

9. A method according to claim 1 wherein the current produced by the fuel cell is greater than 1 mA per cm² of surface area of said electrode.

10. A method according to claim 1 wherein at least a part of the surface of the anode is made of graphite.

11. A fuel cell comprising an anode having a catalyst adsorbed thereon, said catalyst being as defined in claim 1.

12. A fuel cell according to claim 11 wherein at least a part of the surface of the anode is made of graphite.
